(19) United States
(12) Patent Application Publication
(10) Pub. No.: US 2003/0083036 A1
(43) Pub. Date: May 1, 2003

(54) Wireless transmission circuit enabling adjustable radio frequency transmission power

(76) Inventor: Zhi-Min Liu, San Chung City (TW)

Correspondence Address: PRO-TECHTOR INTERNATIONAL SERVICES, 20775 Norada Court, Saratoga, CA, 95070-3018, US

(21) Appl. No.: 10/104,106

(22) Filed: Mar. 21, 2002

(30) Foreign Application Priority Data
Oct. 26, 2001 (TW) 90218399

(51) Int. Cl. H04B 1/16

(52) U.S. Cl. 455/343; 455/522; 455/126

(57) ABSTRACT

A wireless transmission circuit enabling adjustable RF transmission power includes a signal modulator-oscillator stage, a power-amplifier stage, and a filter circuit. A bias voltage condition of an output transistor of the signal modulator-oscillator stage or the power-amplifier stage is adjustable via a bias control circuit, so as to adjust an output power of the signal modulator-oscillator stage or the power-amplifier stage. When a wireless input device employing the wireless transmission circuit is used to work within a short distance, a lower transmission power may be selected for it. And, when the same input device is used to work at a remote location, a higher transmission power may be selected to achieve the remote transmission. In this manner, the wireless input device may have effectively extended battery life.

### BACKGROUND OF THE INVENTION

1. Field of the Invention

The present invention relates to a wireless transmission circuit, and more particularly to a wireless transmission circuit enabling adjustable radio frequency (RF) transmission power, an output transistor of which has a bias voltage condition that could be adjusted to achieve adjustment of an output power of the output transistor.

2. Description of the Prior Art

Various input devices for a computer system in the early stage, such as mouse, keyboard, joystick, track ball, etc., send their input data to the computer system via a data transmission interface, such as a serial port, a parallel port or a universal serial bus (USB). On receipt of the data input from the input devices, the computer system immediately performs corresponding actions.

With the quickly developed computer technologies, the peripherals of a computer system also involve in very high level of electronic technologies. The constant development of RF transmission technique enables many wireless input devices, such as wireless mouse, wireless keyboard, wireless joystick, etc., to become very popular in the markets. Since these wireless input devices are not able to obtain a working current source from the computer system via cables, they must have batteries mounted therein to obtain the required working current source.

To ensure normal usage of wireless devices, it is important for them to have a durable battery life. There is a close relation between the battery life and a consumed power of a wireless device. The wireless device would require different RF transmission powers at an output thereof depending on actual working conditions, such as a distance between a transmission end and a reception end, the material of surrounding working environment, etc. Moreover, the problem of RF interference becomes serious when the wireless devices become highly popular among users. All these problems should be taken into consideration when designing the wireless devices, in order to decrease the use of the battery and avoid mutual interference of RF signals.

### SUMMARY OF THE INVENTION

A primary object of the present invention is to provide an adjustable RF transmission control circuit for a wireless device. When the wireless device is used to work within a short distance, a lower transmission power may be selected for it; and when the wireless device is used in remote transmission, a higher transmission power may be selected. In this manner, the battery of the wireless device could have an extended usable life and meet the requirement of remote transmission.

Another object of the present invention is to provide a wireless transmission circuit enabling adjustable RF transmission power, in which a bias control circuit is employed to adjust an output power of an output transistor in the wireless transmission circuit, so as to adjust the RF transmission power of the entire wireless transmission circuit, and to reduce the power consumption and extend the battery life of the device using the wireless transmission circuit of the present invention.

To achieve the above and other objects, the wireless transmission circuit enabling adjustable RF transmission power includes a signal modulator-oscillator stage and a power-amplifier stage. At least one of these two stages includes a bias control circuit that may be a variable resistance. A bias voltage condition of an output transistor of the signal modulator-oscillator stage or the power-amplifier stage is adjustable via the bias control circuit, so as to adjust the RF transmission power of the wireless transmission circuit. In another embodiment of the present invention, the wireless transmission circuit further includes a multiplier-amplifier stage and a driver stage before the power-amplifier stage. At least one of these stages internally includes a bias control circuit that is able to adjust an output power of that stage according to a desired transmission power and a transmission distance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram explaining the circuit function of a first embodiment of the present invention;

FIG. 2 shows a detailed control circuit diagram for the first embodiment of the present invention;

FIG. 3 is a block diagram explaining the circuit function of a second embodiment of the present invention;

FIG. 4 is a detailed circuit diagram of a first embodiment of a variable bias control circuit that may be adopted in the second embodiment of the present invention shown in FIG. 3;

FIG. 5 is a detailed circuit diagram of a second embodiment of the variable bias control circuit that may be adopted in the second embodiment of the present invention shown in FIG. 3;

FIG. 6 is a detailed circuit diagram of a third embodiment of the variable bias control circuit that may be adopted in the second embodiment of the present invention shown in FIG. 3;

FIG. 7 is a detailed circuit diagram of a fourth embodiment of the variable bias control circuit that may be adopted in the second embodiment of the present invention shown in FIG. 3; and

FIG. 8 is a detailed circuit diagram of a fifth embodiment of the variable bias control circuit that may be adopted in the second embodiment of the present invention shown in FIG. 3.

### DETAILED DESCRIPTION OF THE PREFERRED EMBODIMENTS

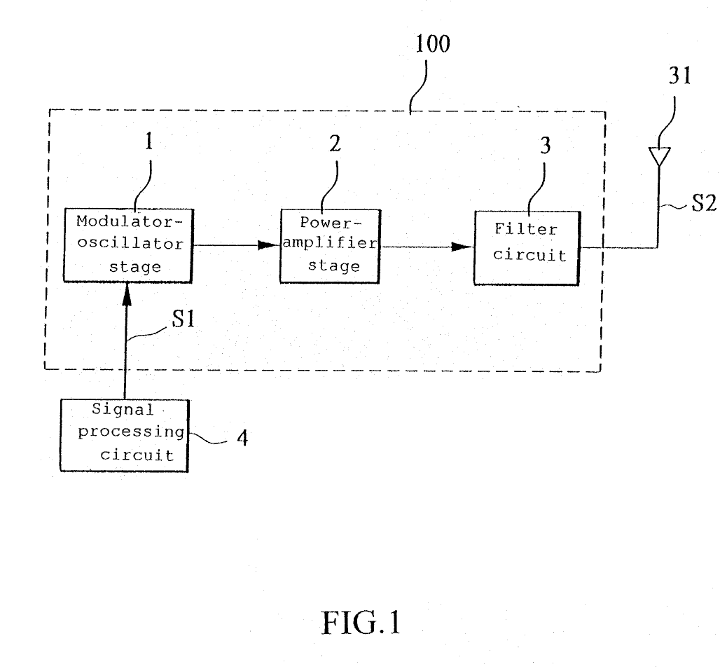

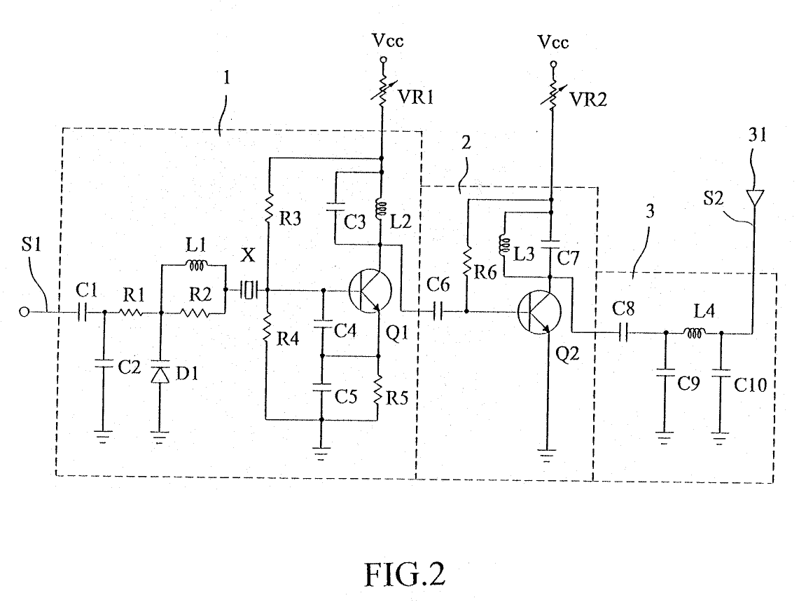

Please refer to FIG. 1 that is a block diagram explaining the circuit function of a wireless transmission circuit 100 enabling adjustable radio frequency (RF) transmission power according to a first embodiment of the present invention, and to FIG. 2 that is a detailed control circuit diagram for the first embodiment of the present invention. The illustrated circuit is normally employed in general wireless input devices or pointing devices.

The wireless transmission control circuit 100 according to the first embodiment of the present invention mainly includes a signal modulator-oscillator stage 1, a power-amplifier stage 2, a filter circuit 3, and an antenna 31. An input of the signal modulator-oscillator stage 1 is connected to a signal processing circuit 4 for receiving an input signal S1 output by the signal processing circuit 4.

The signal processing circuit 4 may be any signal processing circuit for a mouse, a keyboard, a joystick, a track ball, a game controller, a digital signal camera/PC camera, a digital signal video camera/PC video camera, or any other input device or pointing device for generating the input signal S1. The input signal S1 is first sent to the signal modulator-oscillator stage 1 of the wireless transmission control circuit 100, at where the input signal S1 is modulated and then sent via the power-amplifier stage 2 and the filter circuit 3 to the antenna 31 and be emitted.

Please refer to FIG. 2. The signal modulator-oscillator stage 1 provides two major functions, that is, signal modulation and signal oscillation. A modulation circuit included in the signal modulator-oscillator stage 1 consists of capacitances C1 and C2, resistances R1 and R2, an inductance L1, and a diode D1; and an oscillation circuit included in the signal modulator-oscillator stage 1 consists of an oscillator X, resistances R3, R4 and R5, capacitances C3, C4 and C5, an inductance L2, an output transistor Q1, and a variable resistance VR1. The variable resistance VR1 is serially connected to a loop between a working current source Vcc and the output transistor Q1 to serve as a bias control circuit in the present invention.

When the variable resistance VR1 has an increased resistance value, the output transistor Q1 would have a lowered DC (direct current) working point. That is, the output transistor Q1 would have a reduced bias voltage value that results in a reduction of output power of the output transistor Q1. Reversely, when the variable resistance VR1 has a decreased resistance value, the output transistor Q1 would have an ascended DC working point and accordingly an increased bias voltage value that results in an increase of output power of the output transistor Q1. Therefore, the bias voltage condition of the output transistor Q1 may be changed through adjustment of the variable resistance VR1 of the signal modulator-oscillator stage 1 to achieve adjustment of the output power of the signal modulator-oscillator stage 1.

A modulated signal data generated at the signal modulator-oscillator stage 1 is sent to the power-amplifier stage 2 for amplification of RF power. The power-amplifier stage 2 consists of capacitances C6 and C7, a resistance R6, an inductance L3, an output transistor Q2, and a variable resistance VR2. A base of the output transistor Q2 serves as a signal input of the power-amplifier stage 2 and is connected to a collector of the output transistor Q1 of the signal modulator-oscillator stage 1. A collector of the output transistor Q2 serves as an output of the power-amplifier stage 2 and is connected to the filter circuit 3. When the variable resistance VR2 has an increased resistance value, the output transistor Q2 would have a lowered DC working point and accordingly a reduced bias voltage value that results in a reduction of output power of the output transistor Q2. Reversely, when the variable resistance VR2 has a decreased resistance value, the output transistor Q2 would have an ascended DC working point and accordingly an increased bias voltage value that results in an increase of output power of the output transistor Q2. Therefore, the bias voltage condition of the output transistor Q2 may be changed through adjustment of the variable resistance VR2 of the power-amplifier stage 2 to achieve adjustment of the output power of the power-amplifier stage 2.

The filter circuit 3 is connected to the antenna 31 and consists of capacitances C8, C9 and C10, and an inductance L4. The filter circuit 3 filters signal output by the power-amplifier stage 2 and generates a RF signal S2 that is emitted via the antenna 31.

Thus, the transmission power of the wireless transmission circuit 100 is changeable through adjustment of the variable resistances VR1 and VR2 of the signal modulator-oscillator stage 1 and the power-amplifier stage 2, respectively.

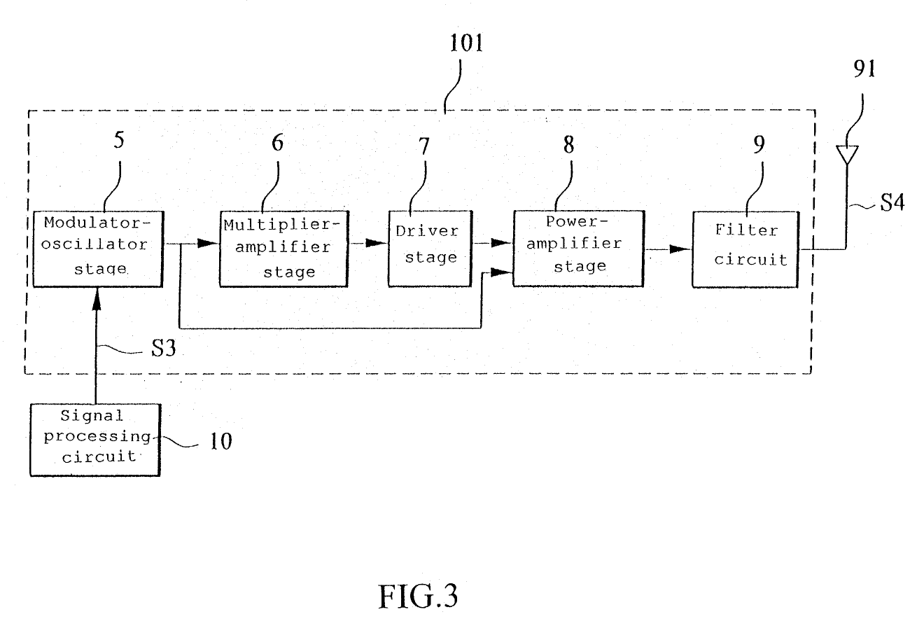

FIG. 3 is a block diagram explaining the circuit function of a wireless transmission circuit 101 enabling adjustable radio frequency (RF) transmission power according to a second embodiment of the present invention. The illustrated circuit is a circuit structure diagram for general wireless transmitters.

The wireless transmission control circuit 101 according to the second embodiment of the present invention mainly includes a signal modulator-oscillator stage 5, a multiplier-amplifier stage 6, a driver stage 7, a power-amplifier stage 8, a filter circuit 9, and an antenna 91. An input of the signal modulator-oscillator stage 5 is connected to a signal processing circuit 10 to receive an input signal S3 output by the signal processing circuit 10.

The input signal S3 is first sent to the signal modulator-oscillator stage 5 of the wireless transmission control circuit 101, at where the signal S3 is modulated and then sent to the multiplier-amplifier stage 6 for signal frequency multiplication, and to the driver stage 7 and the power-amplifier stage 8 for signal power amplification. The signal is finally filtered at the filter circuit 9 to produce a RF signal S4 that is emitted from the antenna 91.

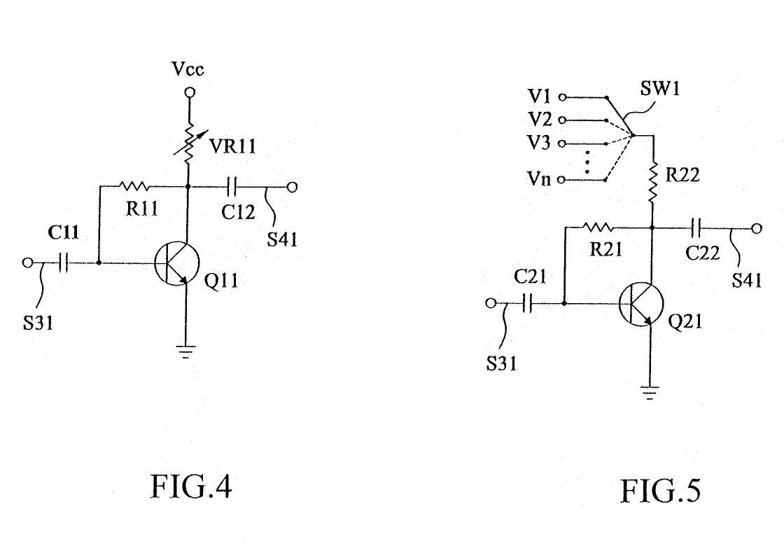

FIG. 4 is a detailed circuit diagram of a first embodiment of a variable bias control circuit adopted in the present invention. The variable bias control circuit of FIG. 4 may be employed in the signal modulator-oscillator stage 5, the multiplier-amplifier stage 6, the driver stage 7 or the power-amplifier stage 8 shown in FIG. 3, in order o modulate, multiply frequency of, or amplify an input signal S31 and to output a signal S41. In the first embodiment, the variable bias control circuit consists of capacitances C11 and C12, a resistance R11, a variable resistance VR11, and an output transistor Q11. In this circuit, the DC power Vcc applied thereto is constant. When the variable resistance VR11 has an increased resistance value, the output transistor Q11 would have a lowered DC working point and accordingly a reduced bias voltage value that results in a decreased output power of the output transistor Q11. Reversely, when the variable resistance VR11 has a decreased resistance value, the output transistor Q11 would have an ascended DC working point and accordingly an increased bias voltage value that results in an increased output power of the output transistor Q11. Therefore, the bias voltage condition of the output transistor Q11 may be changed through adjustment of the variable resistance VR11 to achieve adjustment of the output power of the transistor Q11.

FIG. 5 is a detailed circuit diagram of a second embodiment of the variable bias control circuit adopted in the present invention. The variable bias control circuit of FIG. 5 may also be employed in the signal modulator-oscillator stage 5, the multiplier-amplifier stage 6, the driver stage 7 or the power-amplifier stage 8 shown in FIG. 3. In the second embodiment, the variable bias control circuit consists of capacitances C21 and C22, resistances R21 and R22, and an output transistor Q21. The control circuit may be connected to several working current sources V1, V2, V3 . . . , and Vn having different voltage levels. By operating a selection switch SW1, working current source supplied to the control circuit could be switched to any one of the several working current sources V1, V2, V3 . . . , and Vn. When a working current source having a higher voltage level is selected, the control circuit would have a higher output power. Reversely, when a working current source having a lower voltage level is selected, the control circuit would have a lower output power. Therefore, the output power of the circuit could be adjusted through adjustment of the voltage level of the working current source of the circuit.

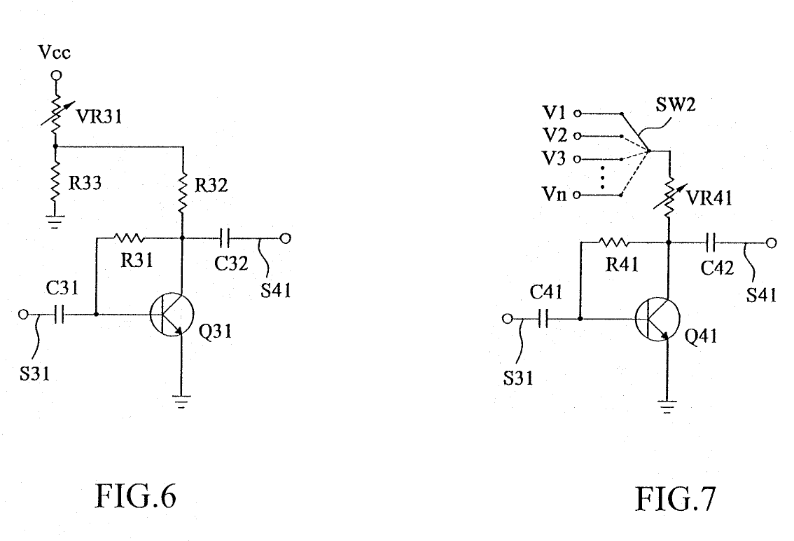

FIG. 6 is a detailed circuit diagram of a third embodiment of the variable bias control circuit adopted in the present invention. The variable bias control circuit of FIG. 6 may also be employed in the signal modulator-oscillator stage 5, the multiplier-amplifier stage 6, the driver stage 7 or the power-amplifier stage 8 shown in FIG. 3. In the third embodiment, the variable bias voltage control circuit consists of capacitances C31 and C32, resistances R31, R32, and R33, a variable resistance VR31, and an output transistor Q31. The resistance R33 and the variable VR31 are serially connected to form a voltage-dividing circuit that is then connected between a working current source Vcc and a ground. Through adjustment of the variable resistance VR31, it is possible to adjust a voltage level of the working current source supplied to the control circuit. When the variable resistance VR31 is adjusted to a higher resistance value, the working current source supplied to the circuit is lower and the output power of the circuit is lower, accordingly. Reversely, when the variable resistance VR31 is adjusted to a lower resistance value, the working current source supplied to the circuit is higher and the output power of the circuit is higher, accordingly. Therefore, the output power of the circuit is adjustable through adjustment of the variable resistance of the circuit.

FIG. 7 is a detailed circuit diagram of a fourth embodiment of the variable bias control circuit adopted in the present invention. The variable bias control circuit of FIG. 7 may also be employed in the signal modulator-oscillator stage 5, the multiplier-amplifier stage 6, the driver stage 7 or the power-amplifier stage 8 shown in FIG. 3. In the fourth embodiment, the variable bias control circuit consists of capacitances C41 and C42, a resistance R41, a variable resistance VR41, and an output transistor Q41. The control circuit may be connected to several working current sources V1, V2, V3 . . . , and Vn having different voltage levels. By operating a selection switch SW2, working current source supplied to the control circuit could be switched to any one of the several working current sources V1, V2, V3 . . . , and Vn. When a working current source having a higher voltage level is selected, the control circuit would have a higher output power. Reversely, when a working current source having a lower voltage level is selected, the control circuit would have a lower output power. Therefore, the output power of the circuit could be adjusted through adjustment of the voltage level of the working current source of the circuit. In addition to a coarse adjustment of the output power by switching among different voltage levels, a fine adjustment of the output power may also be achieved through adjusting the variable resistance VR41 at the same time.

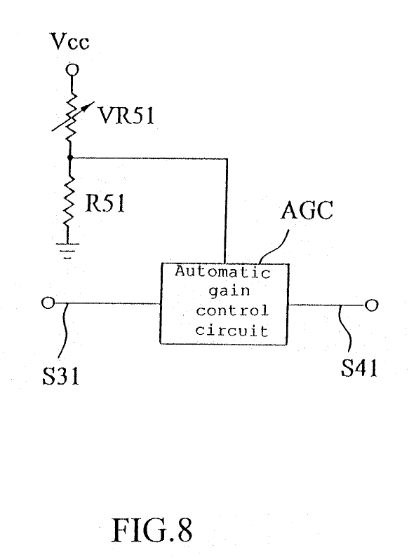

FIG. 8 is a detailed circuit diagram of a fifth embodiment of the variable bias control circuit adopted in the present invention. The variable bias control circuit of FIG. 8 may also be employed in the signal modulator-oscillator stage 5, the multiplier-amplifier stage 6, the driver stage 7 or the power-amplifier stage 8 shown in FIG. 3. In the fifth embodiment, the variable bias control circuit consists of a resistance R51, a variable resistance VR51, and an automatic gain control circuit AGC. When the variable resistance VR51 is adjusted to a higher or a lower resistance value, an adjustment of the output power of the circuit is controlled via the automatic gain control circuit AGC.

When a user operates various input devices in different environments, such as operating a mouse on surfaces made of different materials, for example, wooden desktop and steel desktop, or when there is serious interference among more than one wireless devices, the present invention enables the user to select a proper transmission power to operate the input devices, so as to save power consumption and avoid mutual interference caused by overstrong transmission signals.

From the above description, it is understood the present invention provides a wireless transmission circuit enabling adjustable RF transmission power. When a user uses a wireless input device having the wireless transmission circuit of the present invention to work within a short distance from a computer system, he or she needs only to select a lower transmission power; and when the user uses the same wireless input device to work at a long distance from the computer system, he or she may select a higher transmission power. In this manner, battery loss could be reduced to extend the battery life of the wireless device.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A wireless transmission circuit enabling adjustable radio frequency (RF) transmission power, comprising:
a signal modulator-oscillator stage for receiving signal data output by a signal processing circuit and modulating said received signal; and
a power-amplifier stage for receiving a modulated signal data output by said signal modulator-oscillator stage and amplifying a power of said modulated signal; said power-amplified signal data being further processed and then emitted via an antenna to be received by a receiving device at a remote location; and
at least one of said signal modulator-oscillator stage and said power-amplifier stage including a bias control circuit, with which an output power of said signal modulator-oscillator stage and/or said power-amplifier stage is adjusted according to a desired transmission power and a transmission distance.

2. The wireless transmission circuit enabling adjustable RF transmission power as claimed in claim 1, wherein said power-amplified signal data is processed with a filter circuit before being emitted via said antenna.

3. The wireless transmission circuit enabling adjustable RF transmission power as claimed in claim 1, wherein said signal processing circuit may be a signal processing circuit for any one of a mouse, a keyboard, a joystick, a track ball, a game controller, a digital signal camera or a PC camera, and a digital signal video camera or a PC video camera, to generate said signal data.

4. The wireless transmission circuit enabling adjustable RF transmission power as claimed in claim 1, wherein said bias control circuit includes a variable resistance being serially connected to a loop between a direct current (DC) working current source and an output transistor.

5. The wireless transmission circuit enabling adjustable RF transmission power as claimed in claim 1, wherein said bias control circuit includes a plurality of DC working current sources having different voltage levels, and a selection switch via which one of said plurality of DC working current sources is selected as a working voltage for said output transistor.

6. The wireless transmission circuit enabling adjustable RF transmission power as claimed in claim 1, further comprising:
a multiplier-amplifier stage for multiplying said signal output by said signal modulator-oscillator stage; and
a driver stage for first amplification of a signal output by said multiplier-amplifier stage before the same is sent to said power-amplifier stage; and
at least one of said signal modulator-oscillator stage, said power-amplifier stage, said multiplier-amplifier stage, and said driver stage further including a bias control circuit, with which an output power of said multiplier-amplifier stage and/or said driver stage is adjusted according to a desired transmission power and a transmission distance.

7. The wireless transmission circuit enabling adjustable RF transmission power as claimed in claim 6, wherein said bias control circuit includes a variable resistance being serially connected to a loop between a DC working current source and an output transistor for adjusting a DC working point of said output transistor.

8. The wireless transmission circuit enabling adjustable RF transmission power as claimed in claim 6, wherein said bias control circuit includes a plurality of DC working current sources having different voltage levels, and a selection switch via which one of said plurality of DC working current sources is selected as a working voltage for said output transistor.

9. The wireless transmission circuit enabling adjustable RF transmission power as claimed in claim 6, wherein said bias control circuit includes a voltage-dividing circuit consisting of a resistance and a variable resistance, so that a DC working current source passes said voltage-dividing circuit before being supplied to an output transistor as a working voltage thereof, and that a DC working point of said output transistor is adjustable through adjustment of said variable resistance.

10. The wireless transmission circuit enabling adjustable RF transmission power as claimed in claim 6, wherein said bias control circuit includes:
a variable resistance being serially connected to a loop between a plurality of DC working current sources having different voltage levels and an out,out transistor; and
a selection switch via which one of said plurality of DC working current sources is selected and then sent via said variable resistance to said output transistor as a working voltage thereof; and
a DC working point of said output transistor being adjustable through adjustment of said variable resistance and selection of a desired working voltage from said plurality of working current sources of different voltage levels via said selection switch.

11. The wireless transmission circuit enabling adjustable RF transmission power as claimed in claim 6, wherein said bias control circuit includes a variable resistance and an automatic gain control circuit; and said bias control circuit having a DC working current source that is first supplied to said variable resistance and then to said automatic gain control circuit to serve as a working current source; whereby when said variable resistance is adjusted, an adjustment of output power of said bias control circuit is achieved through controlling of said automatic gain control circuit.

12. A wireless input device having adjustable RF transmission power, comprising a signal processing circuit for outputting a signal data, and an oscillation circuit and an amplification circuit for processing said signal data output by said signal processing circuit; said signal data having been processed by said oscillation circuit and said amplification circuit is wirelessly transmitted and then received by a computer system; and at least one of said oscillation circuit and said amplification circuit having an output bias voltage condition that is adjustable via a bias control circuit according to a desired transmission power and a transmission distance, so as to adjust said transmission power of said wireless input device.

13. The wireless input device having adjustable RF transmission power as claimed in claim 12, wherein said input device may be any one of the following items: a mouse, a keyboard, a joystick, a track ball, a game controller, a digital signal camera or a PC camera, and a digital signal video camera or a PC video camera.

14. The wireless input device having adjustable RF transmission power as claimed in claim 12, wherein said bias control circuit includes a variable resistance being serially connected to a loop between a DC working current source and an output transistor.
